(19) United States
(12) Patent Application Publication
(10) Pub. No.: US 2004/0117833 A1
(43) Pub. Date: Jun. 17, 2004

(54) Media processing system supporting personal network activity indication exchange

(76) Inventors: Jeyhan Karaoguz, Irvine, CA (US); James D. Bennett, Laguna Beach, CA (US)

Correspondence Address: MCANDREWS HELD & MALLOY, LTD, 500 WEST MADISON STREET, SUITE 3400, CHICAGO, IL, 60661

(21) Appl. No.: 10/675,434

(22) Filed: Sep. 30, 2003

Related U.S. Application Data
(60) Provisional application No. 60/478,246, filed on Jun. 13, 2003.
(60) Provisional application No. 60/432,472, filed on Dec. 11, 2002.
(60) Provisional application No. 60/443,894, filed on Jan. 30, 2003.

(51) Int. Cl. H04N 7/18; H04N 7/16; H04N 7/173

(52) U.S. Cl. 725/80; 725/112; 725/134; 725/110; 725/142; 725/117; 725/147

(57) ABSTRACT

A system and method supporting the communication of indication of activity in a communication network are disclosed. An embodiment of the present invention may permit a first user to send an activity indication to a pre-defined group of other users, to enable members of the group of other users to engage in additional media exchange activities with the first user. The activity indication sent to the other users may comprise information descriptive of the media consumption activity of the first user. A user of an embodiment of the present invention may define a set of conditions in which received activity indications result in a notification of the user. Notification of the user may comprise displaying a graphical image, generating a sound, or lighting an indicator on a set top box.

### CROSS-REFERENCE TO RELATED APPLICATIONS/INCORPORATION BY REFERENCE

This application makes reference to, claims priority to, and claims the benefit of U.S. Provisional Patent Application Serial No. 60/478,246, entitled “Media Processing System Supporting Personal Network Activity Indication Exchange” (Attorney Docket 14545US01 01043P-BP-2977), filed Jun. 13, 2003, U.S. Provisional Application Serial No. 60/432,472, entitled “Personal Inter-Home Media Exchange Network” (Attorney Docket No. 14185US01 01001P-BP-2800), filed Dec. 11, 2002, and U.S. Provisional Application Serial No. 60/443,894, entitled “Personal Access And Control Of Media Peripherals On A Media Exchange Network” (Attorney Docket No. 14274US01 01002P-BP-2801), filed Jan. 30, 2003, the complete subject matter of which are hereby incorporated herein by reference, in their entirety.

In addition, the applicants hereby incorporate the complete subject matter herein by reference, in their entirety, of U.S. Provisional Patent Application Serial No. 60/478,287, entitled “Media Processing System Communicating Activity Information To Support User Interaction During Media Broadcasts” (Attorney Docket No. 15039US01 01040P-BP-2846), filed Jun. 13, 2003, U.S. Provisional Patent Application Serial No. 60/448,705, entitled “Media Exchange Network With Media Guide Interface” (Attorney Docket No. 14330US01 01018P-BP-2819), filed Feb. 18, 2003, U.S. Provisional Patent Application Serial No. 60/457,179, entitled “Server Architecture Supporting A Personal Media Exchange Network” (Attorney Docket No. 14825US01 01015P-BP-2831), filed Mar. 25, 2003, U.S. patent application Ser. No. ______, entitled “Personal Inter-Home Media Exchange Network” (Attorney Docket No. 14185US02 01001P-BP-2800), filed Sep. 8, 2003, and U.S. patent application Ser. No. ______, entitled “Personal Access And Control Of Media Peripherals On A Media Exchange Network” (Attorney Docket No. 14274US02 01002P-BP-2801), filed Sep. 11, 2003.

### FEDERALLY SPONSORED RESEARCH OR DEVELOPMENT

[Not Applicable]

### SEQUENCE LISTING

[Not Applicable]

### MICROFICHE/COPYRIGHT REFERENCE

[Not Applicable]

### BACKGROUND OF THE INVENTION

Many users of interactive communication networks are not aware of which of their friends, family, acquaintances, and co-workers are also on-line. They may try sending electronic mail or other communications to those whose email address they can remember, in an attempt to find out if they, too, are online. The target user may be present, but may not wish to be bothered at that time, or may have stepped away from their terminal or PC, and thus fail to respond. When such communications are received, they occur outside the control of the recipient. This may distract or annoy the recipient, particularly if they are engaged in another activity, or do not wish to communicate with the sending party.

Existing communication systems attempt to provide activity information by establishing, for example, user lists that in certain instances, merely indicate the presence of users that are currently online and/or offline. In network environments having a plurality of varying types of access devices or media peripherals, and also a plurality of different media types, such information may not be sufficient to adequately satisfy user or subscriber needs.

Further limitations and disadvantages of conventional and traditional approaches will become apparent to one of skill in the art, through comparison of such systems with the present invention as set forth in the remainder of the present application with reference to the drawings.

### BRIEF SUMMARY OF THE INVENTION

Aspects of the present invention may be found in a method of communicating activity information to support user interaction in a communication network. Such a method may comprise receiving at least one condition, at a first location, the at least one condition defining when an indication of media consumption activity is sent by the first location to at least a second location, via the communication network. An embodiment of the present invention may comprise receiving a request for media consumption, from a user at the first location, and sending at least one indication of media consumption activity to the at least a second location, via the communication network, if the at least one condition is met. Such an embodiment may also comprise refraining from sending at least one indication of media consumption activity to the at least a second location, via the communication network, if the at least one condition is not met.

In an embodiment of the present invention each of the first location and the at least a second location may be associated with at least one of an Internet protocol (IP) address, a media access control (MAC) address, and an electronic serial number (ESN). The communication network may comprise at least one of a cable infrastructure, a satellite network infrastructure, a digital subscriber line (DSL) infrastructure, an Internet infrastructure, an intranet infrastructure, a wired infrastructure, and a wireless infrastructure, and the communication network may be the Internet. The media may comprise at least one of audio, a still image, video, real time video, and data, and consumption may comprise at least one of playing audio, displaying a still image, displaying video, and displaying data.

An embodiment in accordance with the present invention may comprise receiving an identifier identifying the at least a second location, and the identifier may comprise at least one of a legal name, a given name, a screen name, a user identifier, a network identifier, an Internet protocol (IP) address, a media access control (MAC) address, and an electronic serial number. In various embodiments of the present invention, the at least one condition may comprise at least one of a day, a date, a time, time period, a user identifier, a source of media being accessed, a media channel type, a mode, a media format, a genre, a language, a subject, and an artist. The at least one indication of media consumption activity may comprise at least one of a title, a subject, a user identifier, a source of media being accessed, a media channel type, a mode, a media format, a genre, a language, a subject, and an artist. In an embodiment of the present invention, the at least one condition may be received from a location remote from the first location, via the communication network.

Additional aspects of the present invention may be seen in a method of communicating activity information to support user interaction in a communication network. An embodiment in accordance with the present invention may comprise receiving at least one condition used to determine when a user is notified, via the communication network, of the receipt at a first location of an indication of media consumption activity, at least a second location. In addition, an embodiment of the present invention may comprise receiving, at the first location, at least one indication of media consumption activity, from at least the second location, and notifying the user, at the first location, of the receipt of the at least one indication of media consumption activity, if the at least one condition is met. An embodiment of the present invention may refrain from notifying the user, at the first location, of the receipt of the at least one indication of media consumption activity, if the at least one condition is not met.

In an embodiment of the present invention, each of the first location and the at least a second location may be associated with at least one of an Internet protocol (IP) address, a media access control (MAC) address, and an electronic serial number (ESN). The communication network may comprise at least one of a cable infrastructure, a satellite network infrastructure, a digital subscriber line (DSL) infrastructure, an Internet infrastructure, an intranet infrastructure, a wired infrastructure, and a wireless infrastructure, and the communication network may be the Internet. In various embodiments in accordance with the present invention, the media may comprise at least one of audio, a still image, video, real time video, and data, and consumption may comprise at least one of playing audio, displaying a still image, displaying video, and displaying data. An embodiment of the present invention may comprise receiving an identifier identifying the at least a second location, and the identifier may comprise at least one of a legal name, a given name, a screen name, a user identifier, a network identifier, an Internet protocol (IP) address, a media access control (MAC) address, and an electronic serial number.

In various embodiments of the present invention, the at least one condition may comprise at least one of a day, a date, a time, time period, a user identifier, a source of media being accessed, a media channel type, a mode, a media format, a genre, a language, a subject, and an artist. The at least one indication of media consumption activity may comprise at least one of a title, a subject, a user identifier, a source of media being accessed, a media channel type, a mode, a media format, a genre, a language, a subject, and an artist. The notifying may comprise at least one of displaying an image, generating sound, and illuminating a light emitting diode representing the receipt of the at least one activity indication. An embodiment in accordance with the present invention may comprise initiating, from the first location, an exchange of media between the first location and the at least a second location, if the at least one condition is met, and refraining from initiating, from the first location, an exchange of media between the first location and the at least a second location, if the at least one condition is not met.

Further aspects of the present invention may be observed in a system supporting the communication of activity information to support user interaction in a communication network. Such a system may comprise a television display, at a first location, to support the consumption of media by a user, and a storage, at the first location, communicatively coupled to the television display, and having an associated first network address. An embodiment of the present invention may comprise set top box circuitry, at the first location, the set top box circuitry communicatively coupling the television display to the communication network, at least one user defined identifier identifying at least a second location, and at least one user defined condition for notifying a user. An embodiment in accordance with the present invention may comprise software that receives at least one indication of media consumption activity from the at least a second location, via the communication network. Such an embodiment may respond by notifying the user if the at least one user defined condition is met, and may refrain from notifying the user if the at least one user defined condition is not met.

In an embodiment of the present invention, the media may comprise at least one of audio, a still image, video, real time video, and data, and consumption may comprise at least one of playing audio, displaying a still image, displaying video, and displaying data. The associated first and second network addresses may be one of an Internet protocol (IP) address, a media access control (MAC) address, and an electronic serial number (ESN). The communication network may comprise at least one of a cable infrastructure, a satellite network infrastructure, a digital subscriber line (DSL) infrastructure, an Internet infrastructure, an intranet infrastructure, a wired infrastructure, and a wireless infrastructure. The at least one user defined identifier may comprise at least one of legal name, a given name, a screen name, a user identifier, a network identifier, an Internet protocol (IP) address, a media access control (MAC) address, and an electronic serial number. In various embodiments of the present invention, the at least one user defined condition may comprise a day, a date, a time, time period, a user identifier, a source of media being accessed, a media channel type, a mode, a media format, a genre, a language, a subject, and an artist. In addition, the at least one indication of media consumption activity may comprise at least one of a title, a subject, a user identifier, a source of media being accessed, a media channel type, a mode, a media format, a genre, a language, a subject, and an artist.

These and other advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1A is a diagram illustrating a first embodiment of a media exchange network wherein a media processing system supporting personal network activity indication exchange may operate, in accordance with various aspects of the present invention.

FIG. 1B is a diagram illustrating an embodiment of an exemplary notification group setup screen that may be used to support personal network activity indication exchange in a MPS such as the MPS's of FIG. 1A, or a PC, such as the PC of FIG. 1A, in accordance with the present invention.

FIG. 1C illustrates an exemplary notification groups list screen showing the notification groups defined for several users of an MPS such as the MPS of FIG. 1A, in accordance with an embodiment of the present invention.

FIG. 2A is a flowchart illustrating an exemplary method of configuring a notification group in an embodiment in accordance with the present invention.

FIG. 2B is a flowchart illustrating an exemplary method of operating a media processing system supporting personal network activity indication exchange, in an embodiment of a media exchange network in accordance with the present invention.

FIG. 3 is a schematic block diagram of a first exemplary media exchange network in accordance with an embodiment of the present invention.

FIG. 4 is a schematic block diagram of performing personal media exchange over a second exemplary media exchange network in accordance with an embodiment of the present invention.

FIG. 5 is a schematic block diagram of performing third-party media exchange over a third exemplary media exchange network in accordance with an embodiment of the present invention.

FIG. 6 is an exemplary illustration of a media guide user interface in accordance with an embodiment of the present invention.

FIG. 7 is an exemplary illustration of several instantiations of a media guide user interface of FIG. 4 in accordance with an embodiment of the present invention.

FIG. 8 is an exemplary illustration of a media guide user interface showing several options of a pushed media in accordance with an embodiment of the present invention.

FIG. 9A is a schematic block diagram of a media processing system (MPS) interfacing to media capture peripherals in accordance with an embodiment of the present invention.

FIG. 9B illustrates an alternative embodiment of a media processing system (MPS) in accordance with various aspects of the present invention.

FIG. 10 is a schematic block diagram of a PC and an MPS interfacing to a server on a media exchange network in accordance with an embodiment of the present invention.

FIG. 11 is a schematic block diagram of a PC interfacing to personal media capture devices and remote media storage on a media exchange network in accordance with an embodiment of the present invention.

### DETAILED DESCRIPTION OF THE INVENTION

Certain embodiments of the present invention relate to the communication of user activity information. In particular, certain embodiments of the present invention enable a user of a media exchange network to selectively notify other users of their presence and activities on the network, and to selectively receive notification of the presence and online activities of other users on the network.

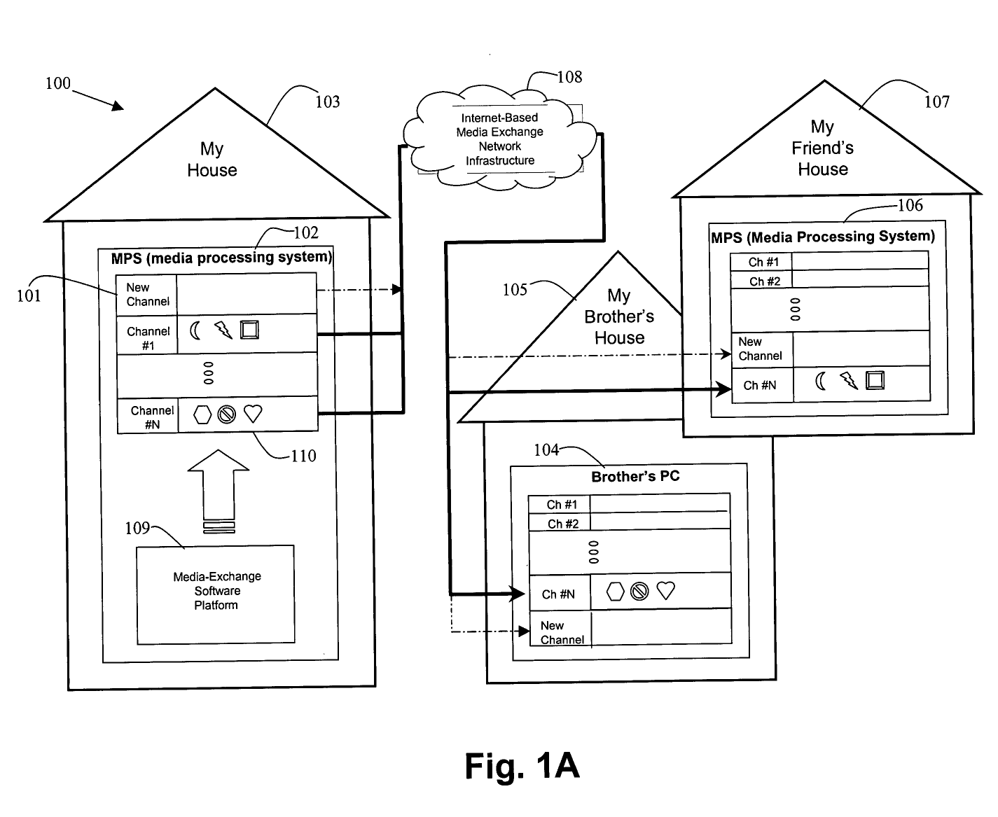

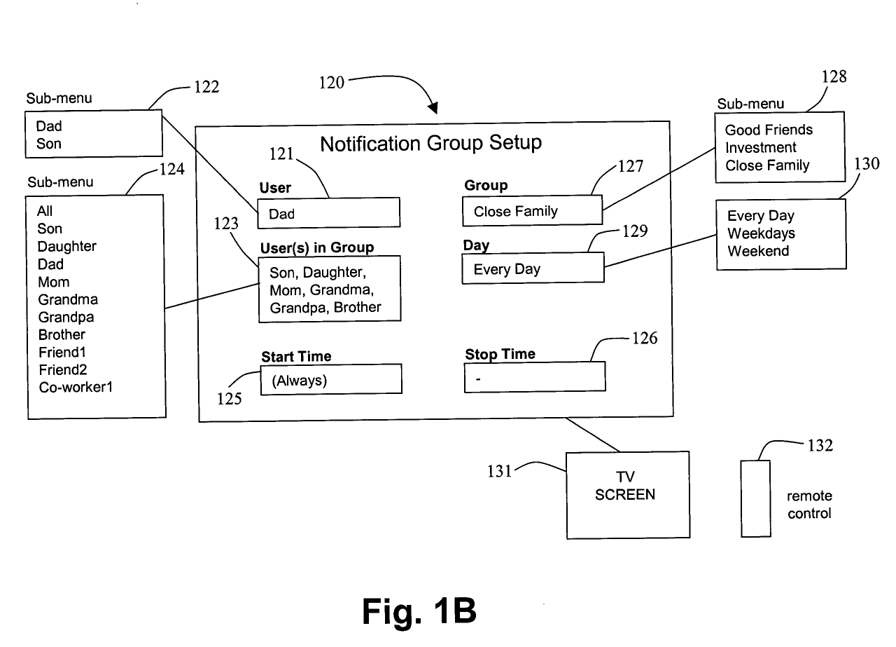

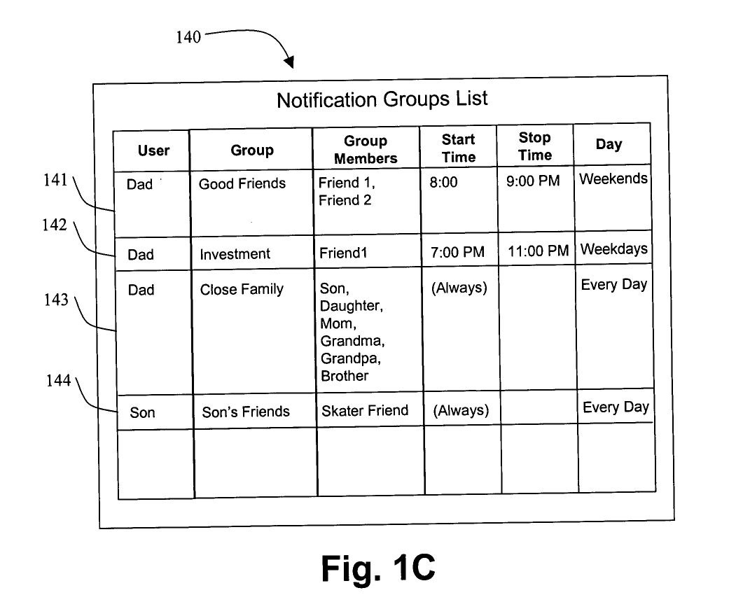

FIG. 1A is a diagram illustrating a first embodiment of a media exchange network 100 wherein a media processing system supporting personal network activity indication exchange may operate, in accordance with various aspects of the present invention. Specifically, the media exchange network 100 is a communication network comprising a MPS (media processing system) 102 at “My House” 103, a brother's PC 104 at “My Brother's House” 105, and a MPS 106 at “My Friend's House” 107. The media exchange network 100 further comprises the Internet-based media exchange network infrastructure 108 which connects together the MPS 102, the PC 104, and the MPS 106. Note that the use labels such as “My House”, “My Brother's House”, etc., are for illustrative purposes only, and do not represent a limitation of the present invention. The Internet-based media exchange network infrastructure 108 may comprise, for example, a wired or wireless network infrastructure, a wide-area network (WAN) infrastructure, a digital subscriber loop (DSL) network infrastructure, an intranet network infrastructure, or any combination of the above. The media exchange network 100 may also contain a variety of other sources of media channel content connected to Internet-base media exchange network 108 that are not shown in FIG. 1A including, for example, 3^{rd} party media providers, 3^{rd} party service providers, 3^{rd} party sales providers, and 3^{rd} party broadcast channel providers. Each of the entities within the media exchange network 100 may be identified using a network or protocol address such as, for example, an Internet protocol (IP) address, a media access control (MAC) address, and an electronic serial number (ESN).

The MPS's 102, 106 may be, for example, enhanced set-top-boxes. The MPS's 102, 106 may each include a TV screen for viewing and interacting with various user interfaces, media, data, and services that are available on the media exchange network using, for example, a remote control. The PC 104 may include a PC monitor for viewing and interacting with various user interfaces, media, data, and services that are available on the media exchange network using, for example, a keyboard and mouse. The MPS's 102, 106 and the PC 104 include functional software to support interaction with the various elements of the media exchange network 100, in accordance with various embodiments of the present invention.

In accordance with various embodiments of the present invention, a MPS may comprise a set-top-box (STB), a PC, or a TV with a media management system (MMS). A MMS is also known herein as a media exchange software (MES) platform.

A MMS comprises a software platform operating on at least one processor to provide certain functionality including user interface functionality, distributed storage functionality, and networking functionality. For example, a MMS may provide control of media peripheral devices, status monitoring of media peripheral devices, and inter-home MPS routing selection, in accordance with an embodiment of the present invention.

For example, the MPS 102 comprises a media exchange software (MES) platform 109. The MES platform 109 on the MPS 102 supports personalized views of media channels and set up of new media channels on the media exchange network 100. For example, the MES platform 109 provides a format, displayed on a monitor of the MPS 102, known as a media guide user interface 110, or “channel view”, to allow a user to set up a personalized view of the media guide user interface 110 using a remote control. An example media guide user interface is described in U.S. Provisional Patent Application Serial No. 60/448,705, entitled “Media Exchange Network With Media Guide Interface” (Attorney Docket No. 14330US01 01018P-BP-2819), filed Feb. 18, 2003, the complete subject matter of which is hereby incorporate herein in its entirety. The MES platform 109 also provides the functionality for a user of the MPS 102 to set up a new media channel 101 in his personalized view.

In general, the MPS's 102, 106 and the PC 104 each include a media exchange software (MES) platform and a networking component for connectivity. The MES platform provides multiple capabilities including media “push” capability, media “access” capability, media channel construction/selection, image sequence selection, text and voice overlay, channel and program naming, inter-home routing selection, authorship and media rights management, shared inter-home media experience, billing service, and an integrated media guide interface with a TV channel guide look-and-feel.

FIG. 1B is a diagram illustrating an embodiment of an exemplary notification group setup screen 120 that may be used to support personal network activity indication exchange in a MPS such as the MPS's 102, 106 of FIG. 1A, or a PC, such as the PC 104 of FIG. 1A, in accordance with the present invention. The notification group setup screen 120 is suitable for viewing on a display device such as, for example, TV screen 131. A user may select options offered by notification group setup screen 120 using, for example, an input device such as remote control 132. As described above, each MPS 102, 106 or PC 104, may have a variety of users, each of whom may have a number of friends, family, co-workers, etc., that may also use a media exchange network, such as the media exchange network 100 of FIG. 1A. In order to permit users of the media exchange network 108 to be aware of the presence and online activities of those with whom they may wish to communicate, the MPS's 102, 106 or the PC 104 may selectively transmit to one or more other users of media exchange network 108 information indicating the presence and online activities of the sending user. In an embodiment in accordance with the present invention, the members of the notification group may be specified using a number of parameters including, for example, a legal name, a given name, a screen name, a user identifier, a network identifier, an Internet protocol (IP) address, a media access control (MAC) address, and an electronic serial number.

An activity indication for a user of the media exchange network 108 may include, for example, a title, a subject, a user identifier, a source of media being accessed, a media channel type, a mode, a media format, a genre, a language, a subject, and an artist. The user of an MPS or PC receiving an activity indication may be notified in the form of a pop up window or ghost overlay on the TV screen of MPS's 102, 106 or on the monitor of PC 104, illumination of a light emitting diode (LED) on the exterior of the MPS's 102, 106, and/or the sound of an audio tone or announcement, in case the user is out of view of the MPS or PC. The transmission of an activity indication may be defined by a user in terms of the conditions in which the media related activity occurs. This may include such things as, for example, the day, date, or time of the activity, the user, the source of media being accessed, the media channel type, the mode, the media format, the genre, the language of any dialogue, the subject, and the artist.

In an embodiment of the present invention, the MPS's 102, 106 or the PC 104 of a user of media exchange network 108 may selectively notify the user of the MPS's 102, 106 or the PC 104 of the receipt of personal network activity indications, in order to allow avoid distracting the user at certain times or during particular activities. The selective notification of the user of an MPS or PC such as, for example, the MPS's 102, 106 or PC 104 enables the user to avoid being notified of received media exchange network activity about which they are not interested. For instance, while some members of a notification group may choose to send activity indications to all other members regarding all of their media exchange network activities, some members of the group may wish to be aware of only certain activities in which they have an interest. Upon receiving a notification of the media network activity of another member of the activity group, a user receiving the notification may choose to engage in direct media exchange with the other member, through the media exchange network, or through an alternate path.

The diagram of FIG. 1B illustrates an exemplary set of parameters that may be used in selecting and identifying the recipients of personal network activity indications, and the conditions under which the personal network activity indications will be shared, in an embodiment in accordance with the present invention. Such an embodiment may support the sharing of activity indications by more than one user of an MPS or PC. Also, using the notification group setup screen 120 of FIG. 1B, each of the users of an MPS or a PC, such as the MPS 102 and the PC 104 of FIG. 1A, may define a number of notification groups, where the members of each notification group may have a particular relationship with the user.

For example, in the illustration of FIG. 1B, the user parameter 121 of the activity group setup screen 120 has been set to “Dad”. This value is selected from the sub-menu of users 122 of the MPS 102 or the PC 104 who have established notification groups (“Dad” and “Son”). In addition, the group parameter 127 is set to “Close Family”, a value selected from “Dad's” notification group sub-menu 128. The remainder of the fields shown in the notification group setup screen 120 show the values that “Dad” set for the respective parameters. For example, “Dad” included “Son”, “Daughter”, “Mom”, “Grandma”, “Grandpa”, and “Brother” in the “User(s) in Group” parameter 123, selected from the sub-menu 124 corresponding to other media exchange network subscribers that are candidates for inclusion in a notification group. Those listed in the “User(s) in Group” parameter 123 who are also media exchange network subscribers are chosen by “Dad” because of a relationship he has with them.

Continuing with respect to FIG. 1B, user “Dad” decided to send activity indications to those listed in the “User(s) in Group” parameter 123 any time that he is connected to the media exchange network 100. This is indicated by the fact that “Dad” set the “Start Time” parameter 125 to the value “(Always)”, and the “Day” parameter 129 to “Every Day”, a value selected from sub-menu 130. As can be seen in FIG. 1B, an embodiment in accordance with the present invention provides a user with a flexible set of controls to selectively share notification of their activation of a media processing system or PC connected to a media exchange network such as media exchange network 100 of FIG. 1A.

FIG. 1C illustrates an exemplary notification groups list screen 140 showing the notification groups defined for several users of an MPS such as the MPS 102 of FIG. 1A, in accordance with an embodiment of the present invention. Four groups have been defined in the illustration of FIG. 1C. Three of the groups belong to user “Dad”: a “Good Friends” group 141, an “Investment” group 142, and a “Close Family” group 144. In addition, user “Son” has defined a “Son's Friends” group 143. Each of the listed activity groups 141, 142, 143, and 144 define a set of conditions under which a personal network activity indication for the corresponding user will be shared, and the identities of the media exchange network subscribers with whom it will be shared. Although the illustrations of FIGS. 1B and 1C show the use of only five parameters, the present invention is not limited in this regard. An embodiment of the present invention may employ a greater, a lesser, or a completely different complement of parameters in controlling the sharing of personal network activity indications in a media exchange network, without departing from the spirit of the present invention. In an embodiment of the present invention, a notification group list showing the notification groups of all users of a MPS or PC, such as that shown in the illustration of FIG. 1C, may be provided only to the administrator of the MPS or the PC, with each user able to view only their own notification groups. In an alternative embodiment, a non-administrative user may be permitted see all notification groups, but permitted to modify only their own entries.

An embodiment in accordance with aspects of the present invention may permit an authorized and authenticated user to establish or modify the parameters used in the sharing of personal network activity indications for a given user of an MPS or a PC, such as the MPS 102 or the PC 104 of FIG. 1A, either directly or remotely. This may be accomplished directly using, for example, the TV screen 131 and remote control 132 of FIG. 1B, that may be connected to a MPS, such as the MPS 102 of FIG. 1A. The setup or modification of notification groups may also be performed directly on a PC, such as PC 104 of FIG. 1A, via the keyboard, mouse, and monitor that may be connected to the PC 104. Notification groups may be defined and configured remotely using another MPS, such as MPS 106 of FIG. 1A, via media exchange network 108, or via a remote PC, such as PC 104, via the Internet. For example, a parent acting as administrator of a MPS or a PC may use a remote MPS or PC to create or modify an notification group. This may be useful to permit a family member who does not have authorization to create an notification group when the administrator parent is away from the MPS.

In another embodiment in accordance with the present invention, either anonymous or identified personal network activity indications may be sent directly or indirectly to the operator of, or a designated entity accessible via a media exchange network such as media exchange network 100. This may permit the recipient of the personal network activity indication to determine the activity or participation level of the subscribers of the media exchange network. In addition, the media provider may provide rewards or incentives, such as coupons, viewing points, or the like, based upon the level of participation or activity information. Entities such as, for example, a 3^{rd} party sales provider, 3^{rd} party service provider, and a 3^{rd} party media provider may find it advantageous to give incentives to subscribers of media exchange network 100 to motivate them to have their MPS or PC activated.

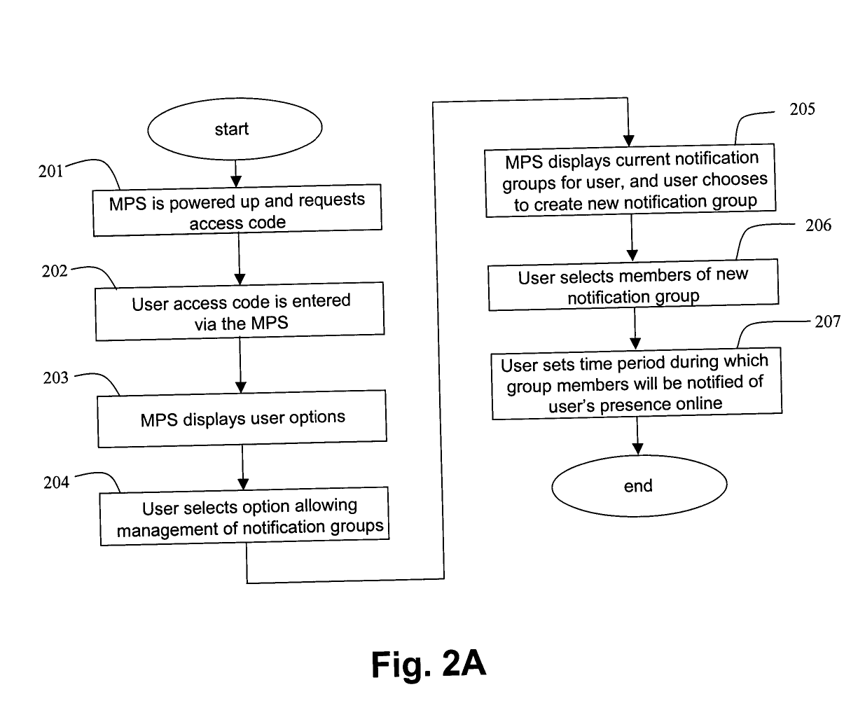

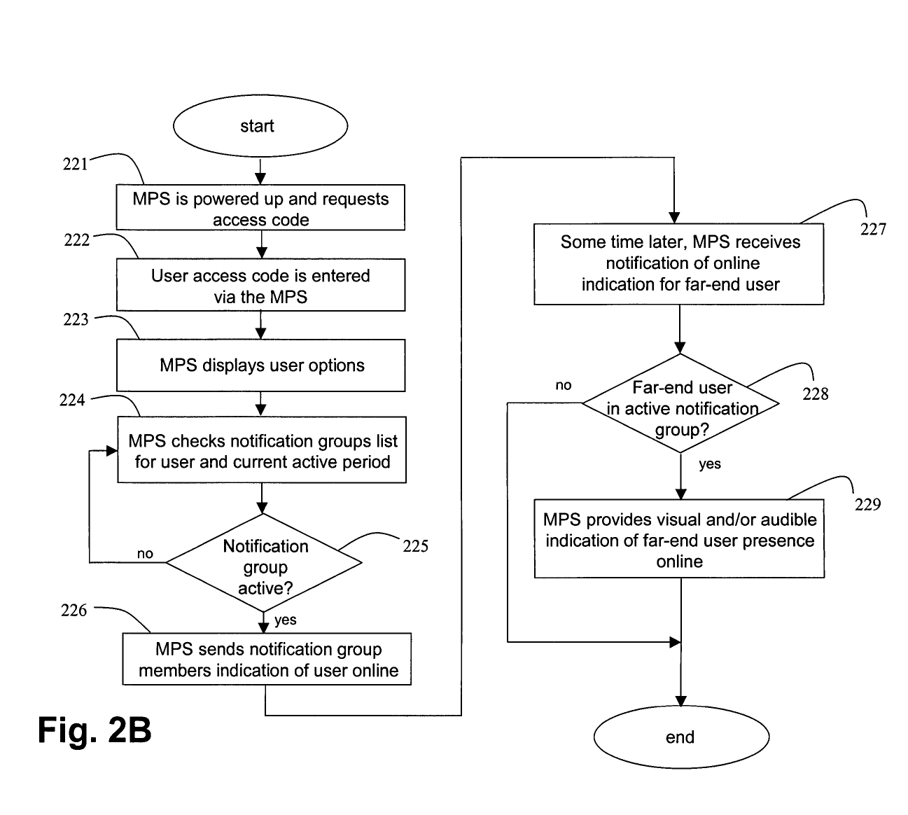

FIG. 2A is a flowchart illustrating an exemplary method of configuring a notification group in an embodiment in accordance with the present invention. Although the following discussion refers to a MPS such as the MPS 102 of FIG. 1A, FIG. 2A applies equally to a PC, such the PC 104 of FIG. 1A. In the illustration of FIG. 2A, the method begins when the user powers up the MPS and the MPS prompts the user for the entry of an access code (block 201). The user then enters an access code (block 202), and the MPS displays the options available to that user (block 203). In the example of FIG. 2A, the user selects the option for the management of notification groups (block 204).

The MPS then displays a current list of notification groups known to the MPS, and the user chooses to create a new notification group (block 205). The user then selects the members of the new notification group (block 206). The user also sets the time period (e.g., time-of-day, days-of-the-week) during which sharing of a personal network activity indication may occur, and during which the user will be notified of receipt of personal network activity indications from other notification group members (block 207).

FIG. 2B is a flowchart illustrating an exemplary method of operating a media processing system supporting personal network activity indication exchange, in an embodiment of a media exchange network in accordance with the present invention. As in FIG. 2A, the following discussion is made with respect to a MPS, such as MPS's 102, 106 of FIG. 1A, but applies equally to a PC on which the media exchange software platform is running, such as the PC 104 of FIG. 1A. The communication of a user activity indication begins after the MPS or PC is turned on, and the MPS displays a prompt requesting the entry of a user access code (block 221). The user then enters an access code via the MPS (block 222), and the MPS displays the current options available to the user (block 223). The MPS then checks the notification groups list for the user, to determine whether a notification group is active at the current time (block 224). If no notification group is currently active, the MPS continues to periodically re-check the list (block 225). If a notification group list entry for the user is currently active, the MPS notifies via the media exchange network, the notification group members identified in the notification group list entry (block 226). At some later time, the MPS receives a notification of online activity of a far-end user (block 227). Upon receiving the notification, the MPS checks whether the far-end user is listed in the currently active notification group for the current user of the MPS (block 228). If the far-end user is listed in the currently active notification group, the MPS provides a visual and/or audible indication of the online presence of the far-end user (block 229). If the far-end user is not listed in the currently active notification group, the MPS takes no further action.

A major challenge is to be able to transfer and share many different types of digital media, data, and services between one device/location and another with ease while being able to index, manage, and store the digital media and data.

For example, it is desirable to be able to distribute and store many types of digital media in a PC and/or television environment in a user-friendly manner without requiring many different types of software applications and/or unique and dedicated interfaces. Any networking issues or other technical issues should be transparent to the users. It is also desirable to take advantage of existing hardware infrastructure, as much as possible, when providing such capability.

In an embodiment of the present invention, a media exchange network is provided that enables many types of digital media, data, and/or services to be stored, indexed, viewed, searched for, pushed from one user to another, and requested by users, using a media guide user interface. The media exchange network also allows a user to construct personal media channels that comprise his personal digital media (e.g., captured digital pictures, digital video, digital audio, etc.), request that third-party media channels be constructed from third-party digital media, and access the media channels pushed to him by other users on the media exchange network.

PC's may be used but are not required to interface to the media exchange network for the purpose of exchanging digital media, data, and services. Instead, set-top-boxes or integrated MPS's (media processing systems) may be used with the media exchange network to perform all of the previously described media exchange functions using a remote control with a television screen.

Current set-top-boxes may be software enhanced to create a MPS that provides full media exchange network interfacing and functionality via a TV screen with a TV guide look-and-feel. PC's may be software enhanced as well and provide the same TV guide look-and-feel. Therefore, the media exchange network supports both PC's and MPS's in a similar manner. Alternatively, a fully integrated MPS may be designed from the ground up, having full MPS capability.

In the case of an MPS configuration, the user takes advantage of his remote control and TV screen to use the media exchange network. In the case of a PC configuration, the user takes advantage of his keyboard and/or mouse to use the media exchange network.

An MPS or enhanced PC is effectively a storage and distribution platform for the exchange of personal and third party digital media, data, and services as well as for bringing the conventional television channels to a user's home. An MPS and/or PC connects to the media exchange network via an existing communication infrastructure which may include cable, DSL, satellite, etc. The connection to the communication infrastructure may be hard-wired or wireless.

The media exchange network allows users to effectively become their own broadcasters from their own homes by creating their own media channels and pushing those media channels to other authorized users on the media exchange network, such as friends and family members.

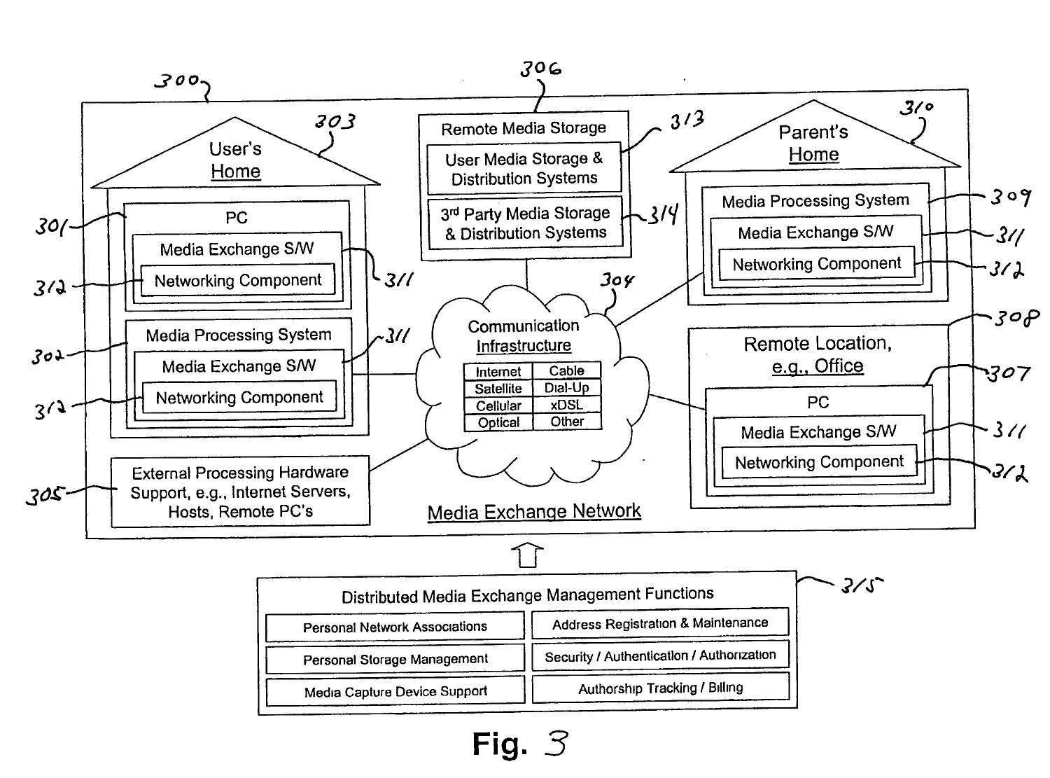

FIG. 3 comprises a media exchange network 300 for exchanging and sharing digital media, data, and services in accordance with an embodiment of the present invention. The media exchange network 300 is a secure, closed network environment that is only accessible to pre-defined users and service providers. The media exchange network of FIG. 3 comprises a first PC 301 and a first media processing system (MPS) 302 at a user's home 303, a communication infrastructure 304, external processing hardware support 305, remote media storage 306, a second PC 307 at a remote location 308 such as an office, and a second MPS 309 at a parent's home 310.

The PC's 301 and 307 and the MPS's 302 and 309 each include a media exchange software (MES) platform 311 and a networking component 312 for connectivity. The MES platform 311 provides multiple capabilities including media “push” capability, media “access” capability, media channel construction/selection, image sequence selection, text and voice overlay, channel and program naming, inter-home routing selection, authorship and media rights management, shared inter-home media experience, billing service, and an integrated media guide interface providing a TV channel guide look-and-feel.

The external processing hardware support 305 comprises at least one server such as a centralized internet server, a peer-to-peer server, or cable head end. The server may alternatively be distributed over various hosts or remote PC's. The MES platform 311 may also reside on the external processing hardware support server 305. The remote media storage 306 may comprise user media storage and distribution systems 313 and/or third party media storage and distribution systems 314.

The communication infrastructure 304 may comprise at least one of internet infrastructure, satellite infrastructure, cable infrastructure, dial-up infrastructure, cellular infrastructure, xDSL infrastructure, optical infrastructure, or some other infrastructure. The communication infrastructure 304 links the user's home 303, parent's home 310, remote media storage 306, and remote location office 308 to each other (i.e., the communication infrastructure 304 links all users and service providers of the media exchange network 300).

The various functions 315 of the media exchange network 300 comprise generating personal network associations, personal storage management, media capture device support, security/authentication/authorization support, authorship tracking and billing and address registration and maintenance. These media exchange management functions 315 may be distributed over various parts of the media exchange network 300. For example, the personal network associations and personal storage management functions may be integrated in the PC 301 at the user's home 303.

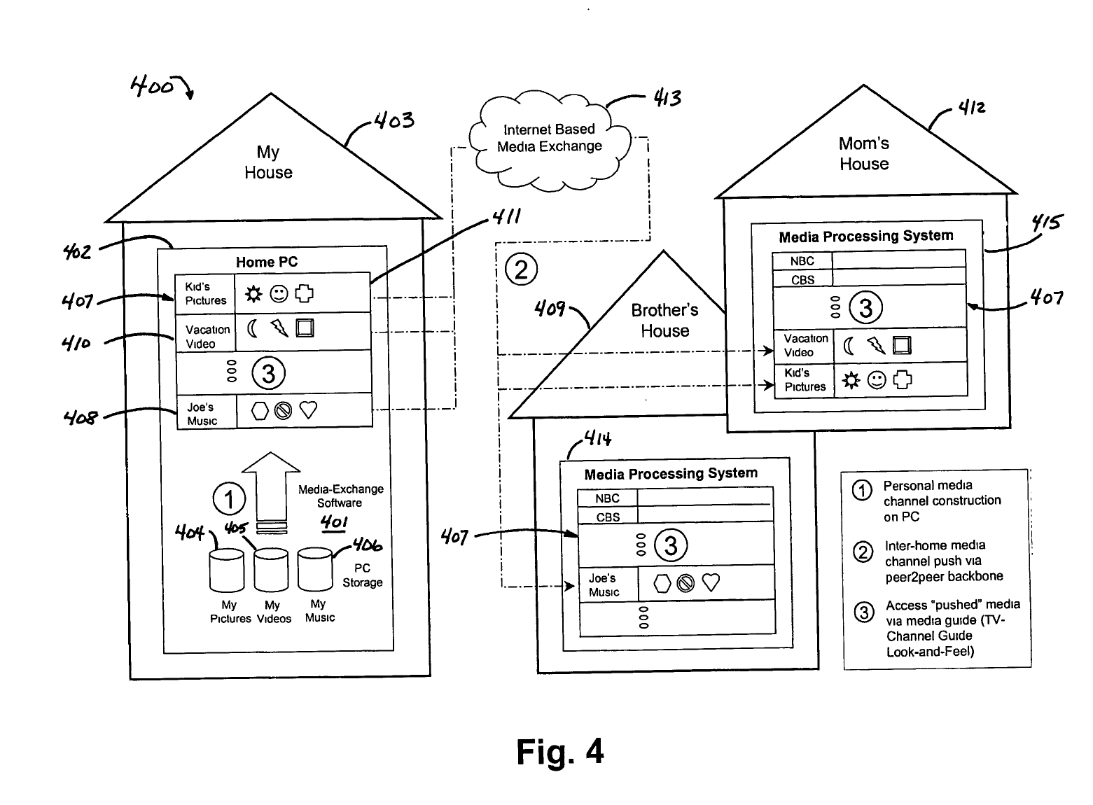

FIG. 4 illustrates an example of personal media exchange over a media exchange network 400 in accordance with an embodiment of the present invention. In step 1, the media exchange software (MES) platform 401 is used to construct personal media channels on a PC 402 by a user at “my house” 403. For example, with various media stored on the PC 402 such as digital pictures 404, videos 405, and music 406, the MES platform 401 allows the digital media to be organized by a user into several channels having a media guide user interface 407 on the PC 402.

In step 2, the user at “my house” 403 pushes a media channel 408 (e.g., “Joe's Music”) to “brother's house” 409 and pushes two media channels 410 and 411 (e.g., “Vacation Video” and “Kid's Pictures”) to “Mom's house” 412 via a peer-to-peer server 413 over the internet-based media exchange network 400. “Brother's house” 409 includes a first MPS 414 connected to the media exchange network 400. “Mom's house” 412 includes a second MPS 415 connected to the media exchange network 400. The MPS's 414 and 415 also provide a media guide user interface 407.

In step 3, brother and/or Mom access the pushed media channels via their respective media processing systems (MPS's) 414 and 415 using their respective MPS TV screens and remote controls.

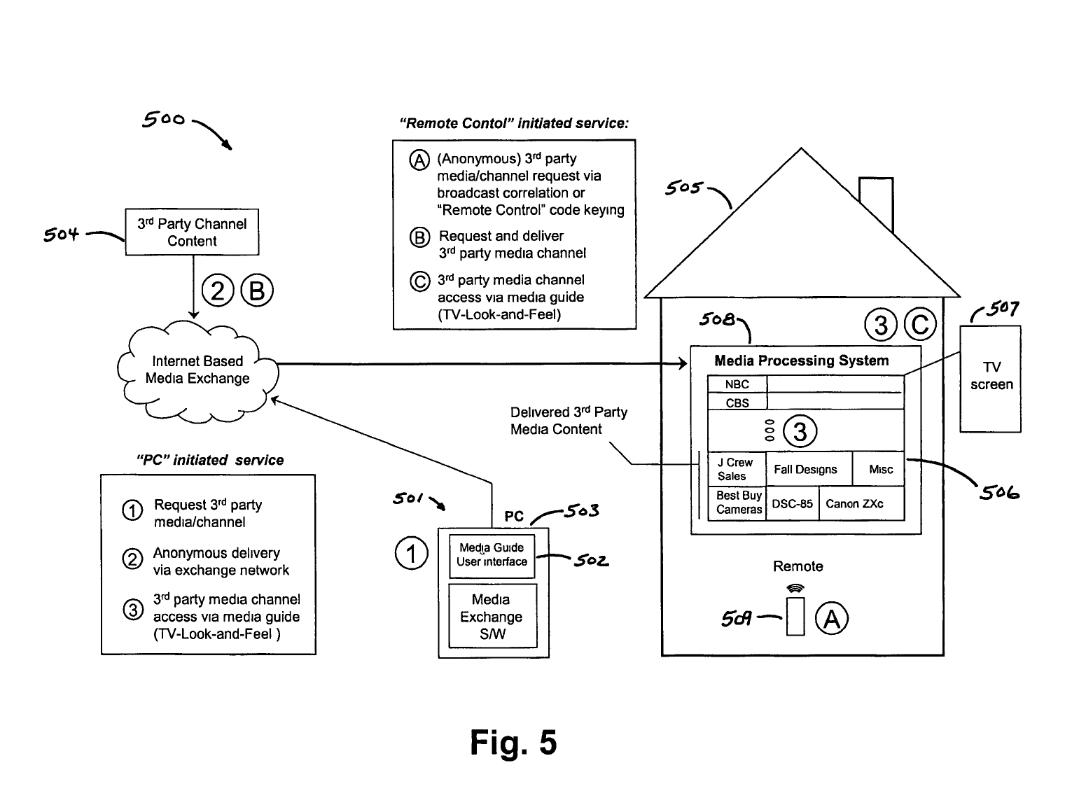

FIG. 5 illustrates an example of third-party media exchange over a media exchange network 500 in accordance with an embodiment of the present invention. In step 1, a PC-initiated third-party request is made by a first party 501 via an internet-based media exchange network 500 using a media guide user interface 502 on a PC 503. In step 2, an anonymous delivery of the requested third-party channel 504 is made to a second party 505 via the internet-based media exchange network 500. In step 3, the second party 505 accesses the third-party channel 504 using a media guide user interface 506 on a TV screen 507 that is integrated into an MPS 508.

Similarly, in step A, an MPS-initiated third-party request is made by a second party 505 via an internet-based media exchange network 500 using a media guide user interface 506 on a TV screen 507 using a remote control 509. The second party 505 may key in a code, using his remote control 509, that is correlated to a commercial or some other third party broadcast media. In step B, an anonymous delivery of the requested third-party channel 504 is made to a first party 501 via the internet-based media exchange network 500. In step C, the first party 501 accesses the third-party channel 504 using a media guide user interface 502 on a PC 503.

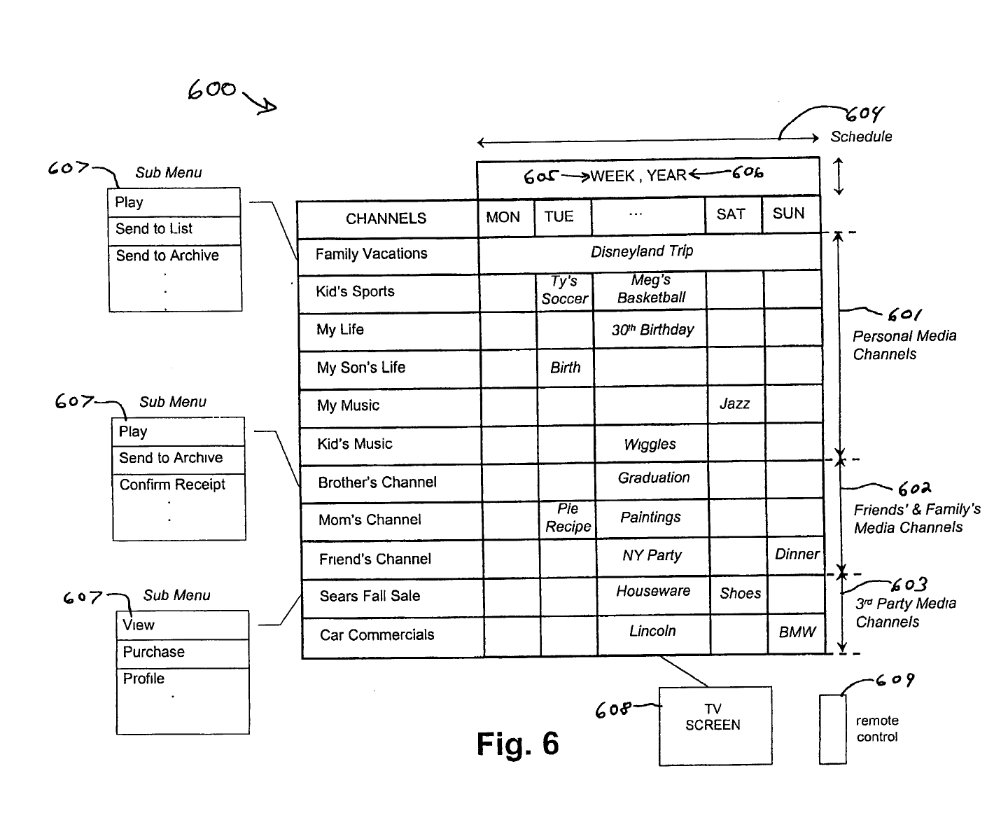

FIG. 6 illustrates a media guide user interface 600 in accordance with an embodiment of the present invention. The media guide user interface 600 may be displayed on a TV screen 608 and controlled by a remote control device 609. Also, the media guide user interface 600 may be displayed on a PC monitor and controlled by a keyboard or mouse.

The media guide user interface 600 may be configured not only for conventional TV channels but also for personal media channels 601 that are constructed by a user of a media exchange network, friend's and family's media channels 602 constructed by friends and family, and third party channels 603 that are constructed by third parties either upon request by a user of a media exchange network or based on a profile of a user.

The personal media channels 601 may include, for example, a “family vacations channel”, a “kid's sports channel”, a “my life channel”, a “son's life channel”, a “my music channel”, and a “kid's music channel”. The friends and family media channels 602 may include, for example, a “brother's channel”, a “Mom's channel”, and a “friend's channel”. The third party media channels 603 may include, for example, a “Sears Fall sale channel” and a “car commercials channel”.

Each media channel may correspond to a schedule 604 showing, for example, a week 605 and a year 606. For example, under the “kid's sports channel”, Ty's soccer game could be scheduled to be viewed on Tuesday of the current week 605 and current year 606. For each media channel, a sub-menu 607 allows for selection of certain control and access functions such as “play”, “send to list”, “send to archive”, “confirm receipt”, “view”, “purchase”, and “profile”.

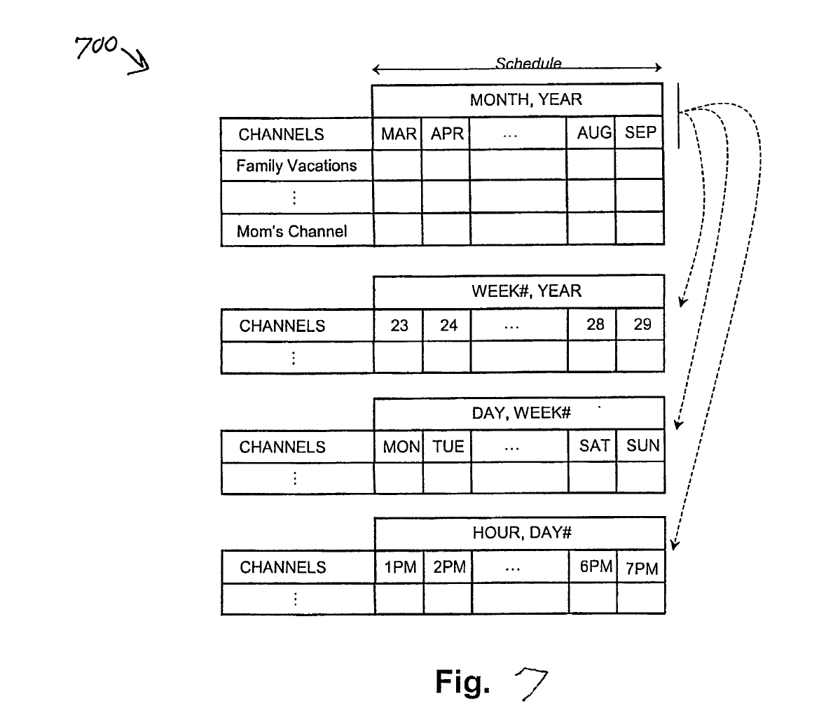

FIG. 7 illustrates possible multiple instantiations of a media guide user interface 700 in accordance with an embodiment of the present invention. The media guide user interface 700 may be viewed with a schedule having formats of, for example, “month, year”, “week#, year”, “day, week#”, or “hour, day”.

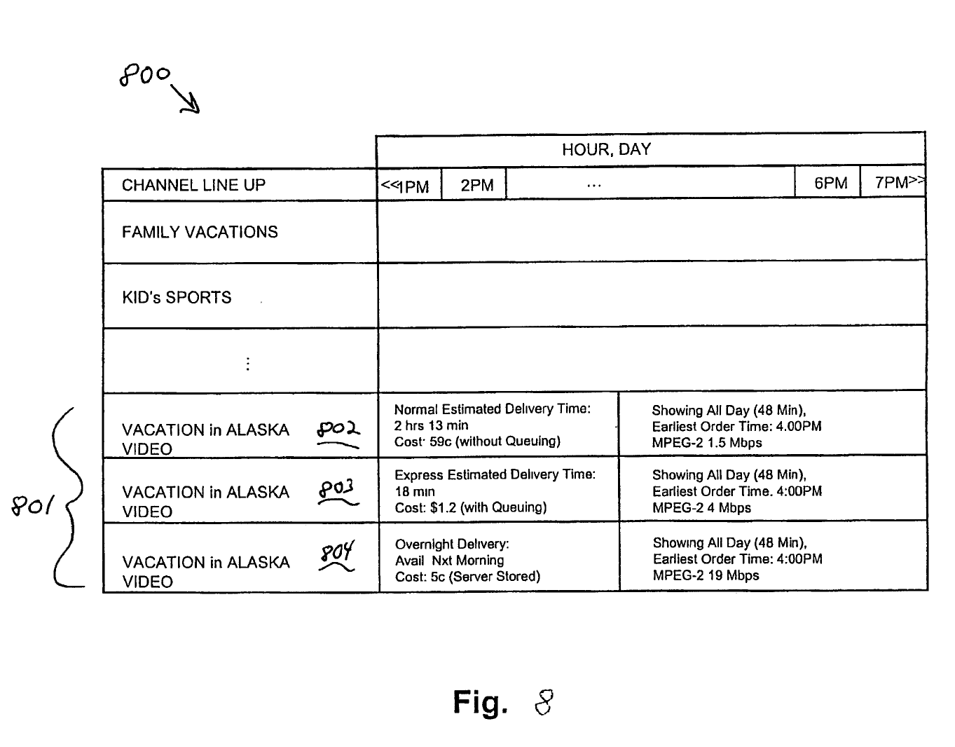

Referring to FIG. 8, a user of a media exchange network may push a media channel (e.g., “Vacation in Alaska Video”) to a friend who is on the same media exchange network. The media guide user interface 800 may give the friend several options 801 for how to accept and download the pushed media in accordance with an embodiment of the present invention.

For example, a first, most expensive option 803 may be “Express Delivery” which would deliver the pushed media to the friend in 18 minutes using queuing and cost $1.20, for example. The pushed media may be stored in a file in an MPEG 2 format that was recorded at a rate of 4 Mbps, for example. Queuing comprises buffering and delivering a previous part of the media and then buffering and delivering a next part of the media. For example, a first six minutes of the “Vacation in Alaska Video” may be buffered and delivered first, then a second six minutes may be buffered and delivered next, and so on until the entire media is delivered.

A second, less expensive option 802 may be “Normal Delivery” which would deliver the pushed media in 2 hours and 13 minutes without queuing and cost $0.59, for example. The pushed media may be stored in a file in an MPEG 2 format that was recorded at a rate of 1.5 Mbps, for example.

A third, least expensive option 804 may be “Overnight Delivery” which would deliver the pushed media by the next morning and cost only $0.05, for example. The pushed media may be stored in a file in an MPEG 2 format that was recorded at a rate of 19 Mbps and stored on a server, for example.

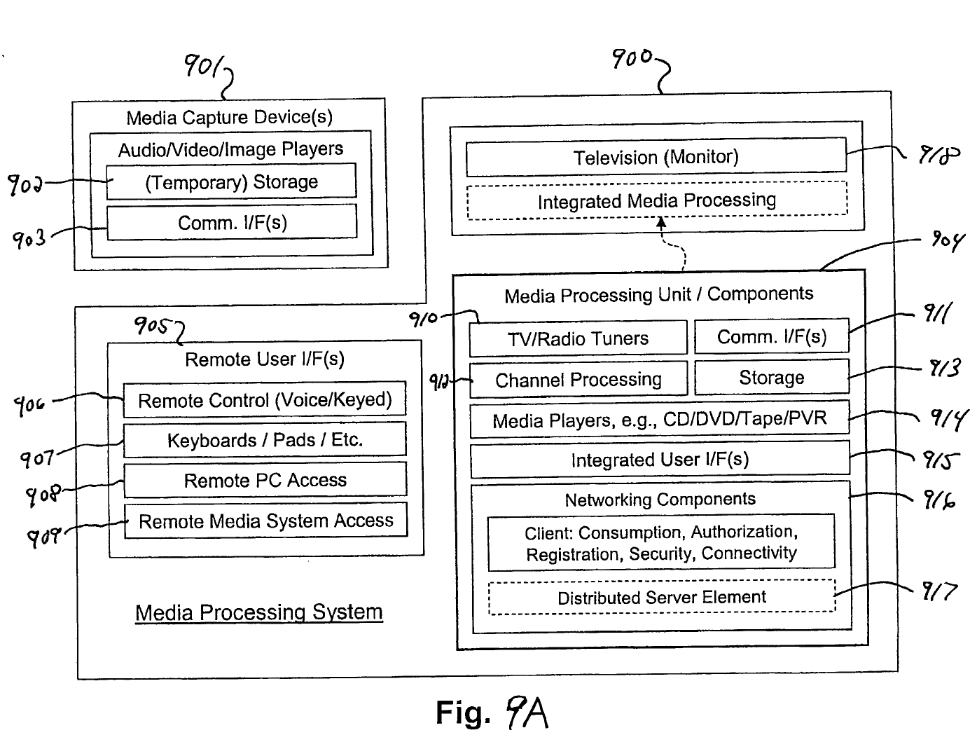

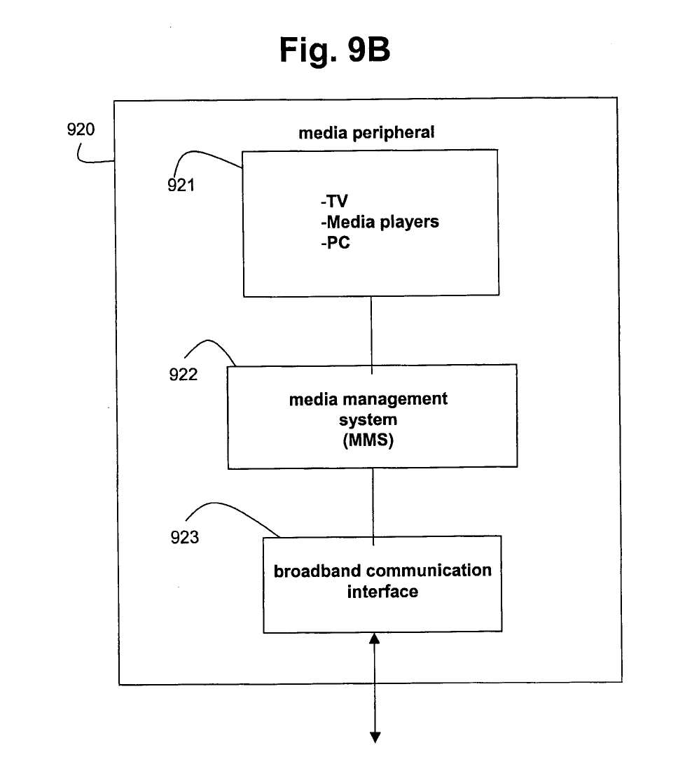

FIG. 9A illustrates the detailed elements of a media processing system (MPS) 900 and media capture devices 901 in accordance with an embodiment of the present invention. The media capture devices 901 may comprise audio, video, and image players, such as digital cameras, digital camcorders, and MP3 players, that each include a temporary storage area 902 and a communication interface 903 such as, for example, a USB interface or a wireless interface. The media capture devices 901 have the capability to interface to an MPS and a PC.

The MPS 900 comprises a media processing unit (MPU) 904, remote user interface(s) 905, and a TV screen 918 to provide integrated media processing capability and indirect user interface capability. The remote user interfaces 905 may comprise a voice or keyed remote control 906, keyboards and pads 907, a remote PC access interface 908, and a remote media system access interface 909 (i.e., providing access from another MPS).

The media processing unit (MPU) 904 comprises TV and radio tuners 910 for image and audio consumption, communications interfaces 911, channel processing 912 (creating, storing, indexing, viewing), storage 913, media players 914 (CD, DVD, Tape, PVR, MP3), an integrated user interface 915 (to provide a TV channel guide look-and-feel), networking components 916 to provide client functions such as consumption (billing), authorization (e.g., using digital certificates and digital ID's), registration, security, and connectivity. In an alternative embodiment of the present invention, the networking components 916 may include a distributed server element 917 that is part of a distributed server.

FIG. 9B illustrates an alternative embodiment of a media processing system (MPS) 920 in accordance with various aspects of the present invention. The MPS 920 is essentially an enhanced set-top-box for viewing and interacting with various user interfaces, media, data, and services that are available on the media exchange network using, for example, a remote control. The MPS 920 comprises a media peripheral 921, a MMS (media management system) 922, and a broadband communication interface 923.

The media peripheral 921 may include a TV (television), a PC (personal computer), and media players (e.g., a CD player, a DVD player, a tape player, and a MP3 player) for video, image, and audio consumption of broadcast and/or personal channels. The broadband communication interface 923 may include internal modems (e.g., a cable modem or DSL modem) or other interface devices in order to communicate with, for example, a cable or satellite headend.

The MMS 922 includes a software platform to provide functionality including media “push” capability, media “access” capability, media channel construction/selection, image sequence selection, text and voice overlay, channel and program naming, inter-home routing selection, authorship and media rights management, shared inter-home media experience, billing service, and a media guide user interface providing an integrated TV channel guide look-and-feel.

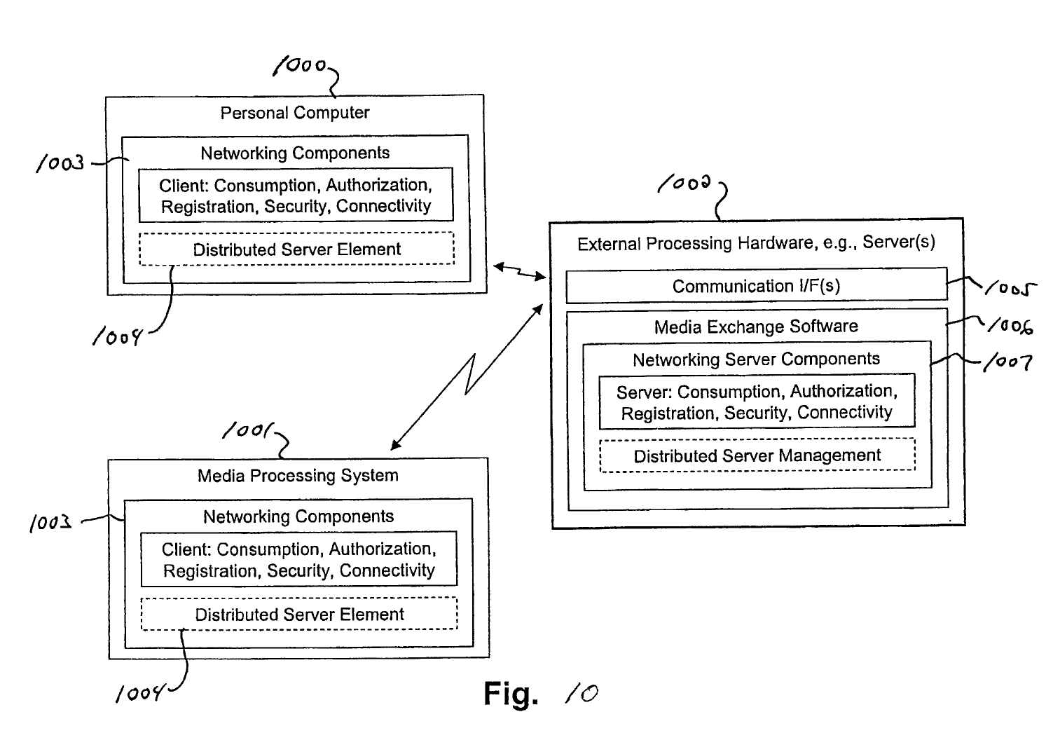

FIG. 10 illustrates connectivity between a PC 1000, an MPS 1001, and external processing hardware 1002 (e.g., a server) in accordance with an embodiment of the present invention. The PC 1000 and MPS 1001 include networking components 1003 to provide client functions such as consumption (billing), authorization, registration, security, and connectivity. Alternatively, the PC 1000 and MPS 1001 may include a distributed server element 1004 that is part of a distributed server.

The PC 1000 and MPS 1001 connect to the external processing hardware 1002 via wired or wireless connections. The external processing hardware 1002 comprises a distributed server or peer-to-peer server. The external processing hardware 1002 also comprises communication interfaces 1005 (e.g., cable interfaces, optical interfaces, etc.) and a media exchange software (MES) platform 1006. The MES platform 1006 in the external processing hardware 1002 allows for communication with the PC 1000 and MPS 1001 which may also use the same MES platform 1006. The external processing hardware 1002 also includes networking server components 1007 to provide the similar client functions such as consumption (billing), authorization, registration, security, and connectivity at the server side.

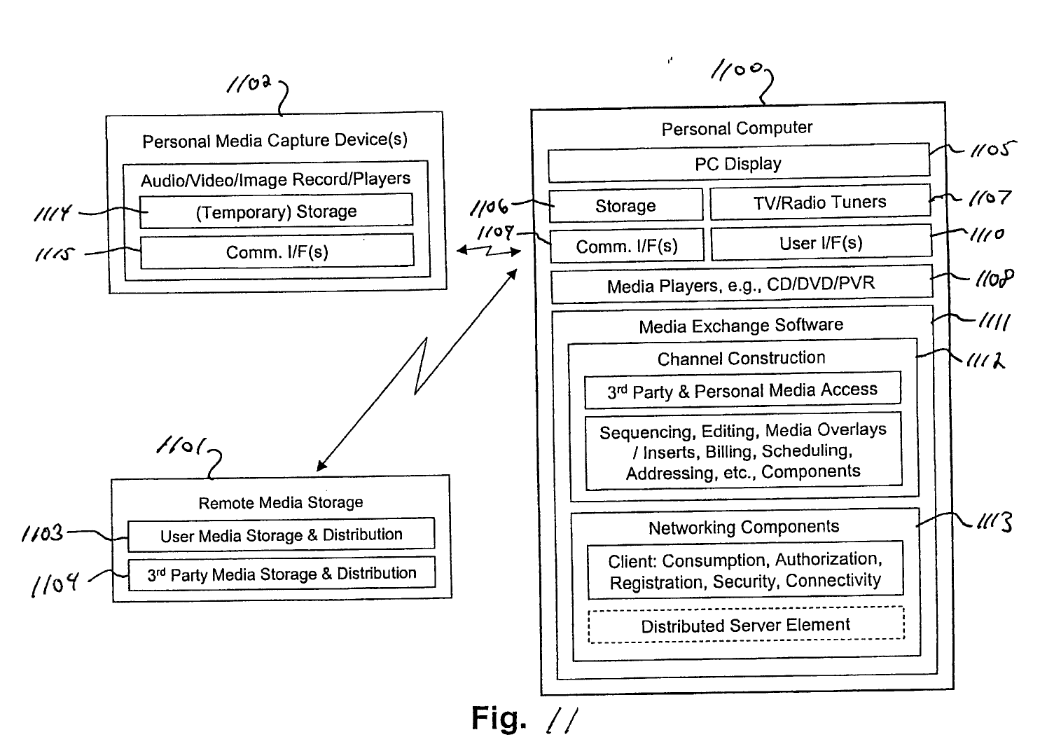

FIG. 11 illustrates connectivity between a PC 1100, remote media storage 1101, and personal media capture devices 1102 when the PC 1100 is used as the primary distributor of digital media such as in the case of PC-to-PC operation, in accordance with an embodiment of the present invention. The personal media capture devices 1102 and remote media storage 1101 connect to the PC 1100 via a wireless or wired connection. The remote media storage 1101 provides user media storage and distribution 1103 as well as third party media storage and distribution 1104. The personal media capture devices 1102 provide temporary storage 1114 and communication interfaces 1115.

Viewing is done using a PC monitor 1105 instead of a television screen. The PC 1100 may include storage 1106, TV/radio tuners 1107 for media consumption, media players 1108, and communication interfaces 1109 and user interfaces 1110 similar to those for the MPS of FIG. 9A. The PC 1100 includes a media exchange software (MES) platform 1111 that provides channel construction capability 1112 and networking capability 1113. The channel construction capability 1112 allows third party and personal media access, sequencing, editing, media overlays and inserts, billing, scheduling, and addressing.

Various embodiments of the present invention include a system and method for operating a media processing system supporting personal network activity indication exchange, as described above.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

What is claimed is:

1. A method of communicating activity information to support user interaction in a communication network, the method comprising:
receiving at least one condition, at a first location, the at least one condition defining when an indication of media consumption activity is sent by the first location to at least a second location, via the communication network;
receiving a request for media consumption, from a user at the first location;
sending at least one indication of media consumption activity to the at least a second location, via the communication network, if the at least one condition is met; and
refraining from sending at least one indication of media consumption activity to the at least a second location, via the communication network, if the at least one condition is not met.

2. The method of claim 1 wherein each of the first location and the at least a second location are associated with at least one of an Internet protocol (IP) address, a media access control (MAC) address, and an electronic serial number (ESN).

3. The method of claim 1 wherein the communication network comprises at least one of a cable infrastructure, a satellite network infrastructure, a digital subscriber line (DSL) infrastructure, an Internet infrastructure, an intranet infrastructure, a wired infrastructure, and a wireless infrastructure.

4. The method of claim 1 wherein the communication network is the Internet.

5. The method of claim 1 wherein the media comprises at least one of audio, a still image, video, real time video, and data.

6. The method of claim 1 wherein consumption comprises at least one of playing audio, displaying a still image, displaying video, and displaying data.

7. The method of claim 1 further comprising:
receiving an identifier identifying the at least a second location; and
the identifier comprising at least one of a legal name, a given name, a screen name, a user identifier, a network identifier, an Internet protocol (IP) address, a media access control (MAC) address, and an electronic serial number.

8. The method of claim 1 wherein the at least one condition comprises at least one of a day, a date, a time, time period, a user identifier, a source of media being accessed, a media channel type, a mode, a media format, a genre, a language, a subject, and an artist.

9. The method of claim 1 wherein the at least one indication of media consumption activity comprises at least one of a title, a subject, a user identifier, a source of media being accessed, a media channel type, a mode, a media format, a genre, a language, a subject, and an artist.

10. The method of claim 1 wherein the at least one condition is received from a location remote from the first location, via the communication network.

11. A method of communicating activity information to support user interaction in a communication network, the method comprising:
receiving at least one condition used to determine when a user is notified, via the communication network, of the receipt at a first location of an indication of media consumption activity, at least a second location;
receiving, at the first location, at least one indication of media consumption activity, from at least the second location;
notifying the user, at the first location, of the receipt of the at least one indication of media consumption activity, if the at least one condition is met; and
refraining from notifying the user, at the first location, of the receipt of the at least one indication of media consumption activity, if the at least one condition is not met.

12. The method of claim 11 wherein each of the first location and the at least a second location are associated with at least one of an Internet protocol (IP) address, a media access control (MAC) address, and an electronic serial number (ESN).

13. The method of claim 11 wherein the communication network comprises at least one of a cable infrastructure, a satellite network infrastructure, a digital subscriber line (DSL) infrastructure, an Internet infrastructure, an intranet infrastructure, a wired infrastructure, and a wireless infrastructure.

14. The method of claim 11 wherein the communication network is the Internet.

15. The method of claim 11 wherein the media comprises at least one of audio, a still image, video, real time video, and data.

16. The method of claim 11 wherein consumption comprises at least one of playing audio, displaying a still image, displaying video, and displaying data.

17. The method of claim 11 further comprising:
receiving an identifier identifying the at least a second location; and
the identifier comprising at least one of a legal name, a given name, a screen name, a user identifier, a network identifier, an Internet protocol (IP) address, a media access control (MAC) address, and an electronic serial number.

18. The method of claim 11 wherein the at least one condition comprises at least one of a day, a date, a time, time period, a user identifier, a source of media being accessed, a media channel type, a mode, a media format, a genre, a language, a subject, and an artist.

19. The method of claim 11 wherein the at least one indication of media consumption activity comprises at least one of a title, a subject, a user identifier, a source of media being accessed, a media channel type, a mode, a media format, a genre, a language, a subject, and an artist.

20. The method of claim 11 wherein the notifying comprises at least one of displaying an image, generating sound, and illuminating a light emitting diode representing the receipt of the at least one activity indication.

21. The method of claim 11 further comprising:
initiating, from the first location, an exchange of media between the first location and the at least a second location, if the at least one condition is met; and
refraining from initiating, from the first location, an exchange of media between the first location and the at least a second location, if the at least one condition is not met.

22. A system supporting the communication of activity information to support user interaction in a communication network, the system comprising:
a television display, at a first location, to support the consumption of media by a user;
a storage, at the first location, communicatively coupled to the television display, and having an associated first network address;
set top box circuitry, at the first location, the set top box circuitry communicatively coupling the television display to the communication network;
at least one user defined identifier identifying at least a second location;
at least one user defined condition for notifying a user; and
software that receives at least one indication of media consumption activity from the at least a second location, via the communication network, and that responds by notifying the user if the at least one user defined condition is met, and that refrains from notifying the user if the at least one user defined condition is not met.

23. The system of claim 22 wherein the media comprises at least one of audio, a still image, video, real time video, and data.

24. The system of claim 22 wherein consumption comprises at least one of playing audio, displaying a still image, displaying video, and displaying data.

25. The system of claim 22 wherein the associated first and second network addresses are one of an Internet protocol (IP) address, a media access control (MAC) address, and an electronic serial number (ESN).

26. The system of claim 22 wherein the communication network comprises at least one of a cable infrastructure, a satellite network infrastructure, a digital subscriber line (DSL) infrastructure, an Internet infrastructure, an intranet infrastructure, a wired infrastructure, and a wireless infrastructure.

27. The system of claim 22 wherein the at least one user defined identifier comprises at least one of legal name, a given name, a screen name, a user identifier, a network identifier, an Internet protocol (IP) address, a media access control (MAC) address, and an electronic serial number.

28. The system of claim 22 wherein the at least one user defined condition comprises a day, a date, a time, time period, a user identifier, a source of media being accessed, a media channel type, a mode, a media format, a genre, a language, a subject, and an artist.

29. The system of claim 22 wherein the at least one indication of media consumption activity comprises at least one of a title, a subject, a user identifier, a source of media being accessed, a media channel type, a mode, a media format, a genre, a language, a subject, and an artist.
